(19) United States
(12) Patent Application Publication
(10) Pub. No.: US 2006/0246311 A1
(43) Pub. Date: Nov. 2, 2006

(54) Substrate for wetting of pre-determined wetting points in a controlled manner with small volumes of liquid, substrate cover and flow chamber

(76) Inventors: Gerhard Hartwich, Munich (DE); Heiko Hillebrandt, Munich (DE)

Correspondence Address: CROCKETT & CROCKETT, 24012 CALLE DE LA PLATA, SUITE 400, LAGUNA HILLS, CA, 92653, US

(21) Appl. No.: 10/550,277

(22) PCT Filed: Mar. 22, 2004
(86) PCT No.: PCT/EP04/02978

§ 371 Date: Mar. 23, 2006

(30) Foreign Application Priority Data
Mar. 21, 2003 (DE) 103 12 670.8

(51) Int. Cl. B32B 9/04

(52) U.S. Cl. 428/543

(57) ABSTRACT

A substrate for the controlled wetting of predetermined wetting sites with small fluid volumes comprises a support plate having a horizontal main surface for wetting with a fluid at predetermined wetting sites, and applied to the support plate, a flat protective layer that separates the main surface from the surroundings, the protective layer exhibiting, extending to the main surface of the support plate, vertical recesses that define the predetermined wetting sites on the support plate and include, leading to the vertical recesses, one or more supply channels having a reduced flat protective layer thickness for supplying the wetting fluid to the predetermined wetting sites. According to a further aspect, the protective layer includes one or more depressions having a reduced flat protective layer thickness for receiving a reservoir volume of wetting fluids and exhibits, disposed in the depressions, extending to the main surface of the support plate, vertical recesses that define the predetermined wetting sites on the support plate and that take up the wetting fluids in the respective depressions.

### FIELD OF THE INVENTION

The present invention relates to a substrate for the controlled wetting of predetermined wetting sites with small fluid volumes. The present invention further relates to a manufacturing method, a substrate covering for such a substrate, and a flow chamber having a substrate and a substrate covering.

### BACKGROUND OF THE INVENTION

The controlled wetting of a substrate with a fluid has broad applications in industry and science. Especially in the field of biosciences, medical devices and sensorics, the manufacture of micropatterned substrates for analytics has been advanced in recent years to obtain so-called lab-on-a-chip products. These products are intended to facilitate, in what is known as high-throughput screening (HTS), automated analysis of a number of possible reactions in a parallel manner in a short time. For these products, however, it is necessary to be able to specifically apply small quantities of fluid on marked locations of the substrate, both in order to functionalize the surfaces and to apply the test fluids in an analysis.

In the field of sensorics, two different approaches are employed for analyzing fluids:

The reaction of two components can be analyzed by mixing, in a reaction vessel, two liquid phases containing the components. Due to this reaction, the properties of the fluids in the reaction vessel change in a detectable manner. On one hand, analytics in the volume phase has the advantage that special proteins retain their specific functions, while on the other hand, the large volumes often required are a disadvantage. Thus, it is necessary to create substrates that provide extremely small reaction vessels.

In another approach, surfaces are used that are provided with various coupling groups and can specifically bind certain analytes in order to analyze unknown fluids for the presence of these analytes. For this, the sensor surface must first be functionalized with the coupling groups, then brought into contact with the unknown fluid, and thereafter, the attachment of the analyte detected. Thus, here again small volumes on substrates must be handled.

For the detection of such binding events on surfaces, a number of methods are available in the art, such as fluorescence spectroscopy, radiometry, electrochemistry and a number of surface-sensitive methods such as AFM, SPR and quartz-crystal oscillators.

Especially in the field of DNA analytics or proteome research, the unknown analyte fluids usually consist of a large number of different substances in extremely small quantities so that, with a view to the cost and time factors that are important for industrial applications, a potential sensor for analyzing these fluids must exhibit a high degree of parallelization, must make do with very small quantities of material and must be very sensitive. The parallelization of such an analysis can be achieved either by lateral patterning of the sensor surface in regions of differing functionalities or, in the case of a volume approach, by a large number of reaction vessels.

For the parallelization of analyses in the volume phase, commercially available microtiter plates can be obtained that can be used with volumes of only about 10 μl per reaction vessel. However, expensive pipetting robots are usually required to achieve the parallel filling of the plates with such small volumes in a short time.

There are two further options available for analyzing an unknown fluid with the aid of the above-described sensor surfaces having laterally bounded regions of differing functionalities: wetting the entire substrate or specifically wetting only the functionalized regions of the substrate with the analyte fluid. However, both of the variations just mentioned for analyzing an unknown fluid with a sensor surface exhibit key disadvantages. The wetting of the entire sensor surface results in a large dead volume, so that this method requires very large fluid quantities. By specifically wetting only the functionalized regions of the substrate surface, the fluid quantity to be used is drastically reduced, but on the other hand, special equipment is needed to facilitate this targeted application of small volumes.

In the art are known, for specifically applying small volumes, commercially available spotters (e.g. from Cartesian Technologies), but they involve considerable acquisition costs and trained personnel. A further method for partially wetting a substrate with a fluid is microcontact printing (μCP), which was first introduced by Whitesides 1994 (A. Kumar, G. M. Whitesides, Science, 1994, 263, 60; U.S. Pat. No. 6,048,623). In this method, a micropatterned stamp is wetted with a fluid, thereafter brought into contact with the substrate to be processed, and in this way, a lateral chemical pattern is stamped on the surface. A great difficulty with this technique is the realization of a uniform contact between the stamp and the substrate, which is decisive for success/quality.

Thus, all known methods for broad applications, for example for standardized analysis in a doctor's office, are suitable only to a limited extent.

### DESCRIPTION OF THE INVENTION

This is where the present invention begins. The object of the present invention, as characterized in the claims, is to specify a substrate and a method for its manufacture that facilitates the controlled wetting of predetermined wetting sites with small fluid volumes, especially for analysis purposes, and avoids the above-mentioned disadvantages of the background art.

According to the present invention, this object is solved by the substrate according to claim 1 or claim 28, the substrate covering according to claim 45, the flow chamber according to claim 47 and the manufacturing method according to claim 50 or claim 51. Further advantageous details, aspects and embodiments of the present invention are evident from the dependent claims, the description, the drawings and the examples.

The following abbreviations and terms will be used in the context of the present invention:

### GENERAL

μCP microcontact printing
AFM atomic force microscope
analyte fluid A fluid potentially containing an analyte that is to be detected using a sensor.
fluid not just pure liquid substances, but also fluids with detergent, any kind of dissolved organic or inorganic substances, as well as emulsions, suspensions and colloidal solutions
functionalization Applying ligate molecules to the wetting sites of a substrate. These molecules can be physisorbed or chemisorbed on the substrate, or bound to it covalently, coordinatively or by complex formation.
HTS high-throughput screening
laser ablation partial or complete removal of organic or inorganic protective layers, as well as the removal of impurities on a support plate by irradiation with laser light
solder resist Paint known from printed circuit board technology, applied to boards to prevent the formation of solder bridges in automated soldering.
pseudo-contact printing The application of a fluid with the aid of a needle, capillary, tweezer, ring or stamp, or an arrangement of needles, capillaries, tweezers, rings or stamps on a patterned substrate, wherein no direct contact occurs between the apparatus and the substrate due to the protective layer and the lateral dimension of the tips of the wetting apparatus, which are preferably larger than the exposed surfaces to be wetted.
protective layer A layer applied to the support plate prior to the actual wetting. For this, any material can be used that forms a complete layer on a surface and thus separates the substrate surface from the surroundings and can later be removed partially and without residue by laser ablation. This protective layer can consist of organic or inorganic materials and, depending on the substrate type and application requirements, can be physisorbed or chemisorbed or bound covalently, coordinatively or by complex formation and applied with any techniques.
SEM scanning electron microscopy
support plate A solid having a freely accessible horizontal main surface that can thus be wetted with a fluid. Plastics as well as metals, semiconductors, glasses, composites and porous materials can be used as the solid support plate.
UV ultraviolet light

### GENETICS

DNA deoxyribonucleic acid
RNA ribonucleic acid
PNA peptide nucleic acid (Synthetic DNA or RNA in which the sugar-phosphate moiety is replaced by an amino acid. If the sugar-phosphate moiety is replaced by the —NH—(CH₂)₂—N(COCH₂— base)—CH₂CO— moiety, PNA will hybridize with DNA.)
A adenine
G guanine
C cytosine
T thymine
base A, G, T, or C
bp base pair
nucleic acid At least two covalently linked nucleotides or at least two covalently linked pyrimidine (e.g. cytosine, thymine or uracil) or purine bases (e.g. adenine or guanine). The term nucleic acid refers to any “backbone” of the covalently bound pyrimidine or purine bases, such as the sugar-phosphate backbone of DNA, cDNA or RNA, a peptide backbone of PNA, or analogous structures (e.g. a phosphoramide, thiophosphate or dithiophosphate backbone). An essential feature of a nucleic acid within the meaning of the present invention is that it can sequence-specifically bind naturally occurring cDNA or RNA.
nucleic acid oligomer A nucleic acid of a base length that is not further specified (e.g. nucleic acid octamer: a nucleic acid having any backbone in which 8 pyrimidine or purine bases are covalently bound to one another).
oligomer equivalent to nucleic acid oligomer
oligonucleotide Equivalent to oligomer or nucleic acid oligomer, in other words e.g. a DNA, PNA or RNA fragment of a base length that is not further specified.
oligo abbreviation for oligonucleotide
ss single-strand

### CHEMICALS

fluorophore A chemical compound (chemical substance) that is capable of giving up, upon excitation with light, a longer-wave (red-shifted) fluorescent light. Fluorophores (fluorescent dyes) can absorb light in a wavelength range from the ultraviolet (UV) to the visible (VIS) to the infrared (IR) range. The absorption and emission maxima are typically shifted against each other by 15 to 40 nm (Stokes shift).
fluorescein resorcinolphthalein
ligand Refers to molecules that are specifically bound by ligates; examples of ligands within the meaning of the present text are substrates, cofactors and coenzymes of a protein (of an enzyme), antibodies (as the ligand of an antigen), antigens (as the ligand of an antibody), receptors (as the ligand of a hormone), hormones (as the ligand of a receptor) and nucleic acid oligomers (as the ligand of the complementary nucleic acid oligomer).
ligate Refers to a (macro-)molecule on which are located specific recognition and binding sites for the formation of a complex with a ligand (template).
SDS sodium dodecyl sulfate
spacer Any molecular link between two molecules or between a surface atom, surface molecule or a surface molecule group and another molecule, normally alkyl, alkenyl, alkynyl, heteroalkyl, heteroalkenyl, or heteroalkynyl chains. Preferred spacers are those having a chain length of 1-20, especially a chain length of 1-14, the chain length representing the shortest continuous link between the structures to be linked.
Au—S—(CH₂)₂-ss-oligo-fluorescein A gold surface having a covalently applied monolayer consisting of derivatized single-strand oligonucleotide. Here, the oligonucleotide's terminal phosphate group at the 3′-end is esterified with (HO—(CH₂)₂—S)₂ to form P—O—(CH₂)₂—S—S—(CH₂)₂—OH, the S—S bond being homolytically cleaved and producing one Au—S—R bond each. At the free end, the probe oligonucleotide bears a covalently attached fluorophore fluorescein.
oligo-spacer-S—S-spacer-oligo Two identical or different nucleic acid oligomers that are linked with each other via a disulfide bridge, the disulfide bridge being attached to the nucleic acid oligomers via any two spacers, and the two spacers being able to have differing chain lengths (the shortest continuous link between the disulfide bridge and the respective nucleic acid oligomer), especially any chain length between 1 and 14, and these spacers, in turn, being able to be bound to various reactive groups that are naturally present on the nucleic acid oligomer or that have been affixed thereto by modification.
(n×HS-spacer)-oligo A nucleic acid oligomer to which n thiol functions are each attached via a spacer, each spacer being able to exhibit a different chain length (the shortest continuous link between the thiol function and the nucleic acid oligomer), especially any chain length between 1 and 14. These spacers, in turn, can be bound to various reactive groups that are naturally present on the nucleic acid oligomer or that have been affixed thereto by modification, and “n” is any integer, especially a number between 1 and 20.
(n×R—S—S-spacer)-oligo A nucleic acid oligomer to which n disulfide functions are each attached via a spacer, the disulfide function being saturated by any residue R. Each spacer for attaching the disulfide function to the nucleic acid oligomer can exhibit a different chain length (shortest continuous link between the disulfide function and the nucleic acid oligomer), especially any chain length between 1 and 14. These spacers, in turn, can be bound to various reactive groups that are naturally present on the nucleic acid oligomer or that have been affixed thereto by modification. The variable “n” is any integer, especially a number between 1 and 20.

In a first aspect, a generic substrate according to the present invention comprises a support plate having a horizontal main surface for wetting with a fluid at predetermined wetting sites, and applied to the support plate a flat protective layer that separates the main surface from the surroundings. The protective layer exhibits, extending to the main surface of the support plate, vertical recesses that define the predetermined wetting sites on the support plate, and includes, leading to the vertical recesses, one or more supply channels having reduced thickness in the flat protective layer for supplying the wetting fluid to the predetermined wetting sites.

Within the meaning of the present invention, the term fluid includes not just pure liquid substances, but also fluids with detergent, any kind of dissolved organic or inorganic substances, as well as emulsions, suspensions and colloidal solutions.

The structure comprising supply channels that lead to the wetting sites considerably reduces the analyte fluid required for an analysis compared with the wetting of the entire substrate.

According to a preferred embodiment, the vertical recesses are disposed in the supply channel or supply channels. In particular, any vertical recess can lie in exactly one supply channel and can thus be supplied by it with the wetting fluid. According to another preferred variation, each vertical recess lies at the intersection point of multiple supply channels. While, according to the present invention, it is preferred that each vertical recess lies at the intersection point of exactly two supply channels, variations in which each vertical recess lies at the intersection point of, for example, three or four supply channels are also part of the present invention.

In this context, it can also advantageously be provided that, at one intersection point of two or more supply channels lies, in each case, one group of multiple vertical recesses. Depending on the intended application, one such group can comprise, for example, four or sixteen individual recesses and serves particularly to improve measuring statistics.

Advantageously, the vertical recesses or groups of recesses are disposed in the form of an n×m matrix having n rows and m columns, n and m being greater than or equal to 2, and n and m each preferably lying between 10 and 1000. Here, it is preferred that the number n of rows and the number m of columns are identical, and/or that the lateral spacings between adjacent recesses or groups of recesses are identical in the rows and columns.

In a particularly preferred embodiment, the m recesses or groups of recesses in one row are each disposed in one of n parallel row supply channels. Advantageously, the n recesses or groups of recesses in one column can each be disposed in one of m parallel column supply channels, so that each recess lies at the intersection point of one row supply and one column supply channel. Advantageously, the row supply channels and the column supply channels exhibit an identical cross-sectional shape.

In another particularly preferred embodiment, one n′×m′ sub-matrix of recesses or groups of recesses is disposed in one meander-shaped supply channel each, wherein n=kₙ*n′ and m=kₘ*m′, with integers kₙ and kₘ being greater than or equal to 1. For example, kₙ and kₘ can both be equal to 1, so that n′=n and m′=m, in other words, all wetting sites of the n×m recess matrix are disposed in a single meander-shaped supply channel and are supplied by it with the wetting fluid. If, according to another example, kₙ=n/2 and kₘ=1 are selected, such that n′=2 and m′=m, then two row channels are combined each time to form one U-shaped channel. In this case, the inlet and outlet of the channels lie on the same side of the substrate.

Compared with the thickness of the protective layer outside the recesses and supply channels, the thickness of the protective layer in the supply channels is reduced by 10% to 99%, preferably by 20% to 95%, particularly preferably by 50% to 95%.

In an advantageous embodiment, the protective layer outside the recesses and supply channels exhibits a thickness d_{S} between 50 μm and 200 μm, preferably between 100 μm and 150 μm. In the supply channels, the protective layer exhibits a reduced thickness d_{K} between 5 μm and 150 μm, preferably between about 10 μm and about 50 μm.

The supply channels preferably run substantially parallel to the main surface of the support plate. However, they can also exhibit a slight uphill or a slight downhill gradient. The cross section of the supply channels is advantageously rectangular or trapezoidal. This facilitates problem-free manufacturing and ensures a good closure of the channels when using the substrate covering described below.

Advantageously, the supply channels exhibit a characteristic width b_{K} between 5 μm and 250 μm, preferably of about 10 μm to about 150 μm. Here, for a rectangular cross section, the characteristic width b_{K} is given simply by the constant width of the channels. For supply channels having a trapezoidal cross section, the characteristic width b_{K} is given by the arithmetic mean of the width of the channel at the bottom and at the upper channel boundary. By analogy, a characteristic width b_{K} for other cross-sectional shapes results from the condition that the product of the characteristic width and the channel depth equals the cross-sectional area.

According to the present invention, the wetting sites exhibit a characteristic dimension of about 5 μm to about 200 μm, preferably of about 10 μm to about 100 μm.

According to an advantageous embodiment of the substrate according to the present invention, the vertical recesses exhibit a substantially rectangular, elliptical or circular cross section. In the latter case, the characteristic dimension mentioned is given by the circle radius, and in the other cases by the arithmetic mean of the side lengths or the large and small ellipsis axes.

To form flow chambers, the substrate can be covered with a cover plate that closes the supply channels in the up direction.

In a second aspect, the present invention comprises a generic substrate having a support plate having a horizontal main surface for wetting with a fluid at predetermined wetting sites, and applied to the support plate, a flat protective layer that separates the main surface from the surroundings, the protective layer including one or more depressions having reduced thickness in the flat protective layer for taking up a reservoir volume of wetting fluids, and exhibiting, disposed in the depressions, extending to the main surface of the support plate, vertical recesses that define the predetermined wetting sites on the support plate, and that take up the wetting fluid from the respective depression. This embodiment of the present invention constitutes a simple variation to wet groups of wetting sites with one type of fluid each.

The vertical recesses are each preferably disposed in the depressions in the form of an n×m matrix having n rows and m columns, n and m being greater than or equal to 2, and n and m each preferably lying between 4 and 20. Here, it is preferred if the number n of rows and the number m of columns are identical, and/or if the lateral spacings between adjacent recesses are identical in the rows and columns.

As with the first aspect of the present invention, compared with the thickness of the protective layer outside the recesses and depressions, the thickness of the protective layer in the depressions is reduced by 10% to 99%, preferably by 20% to 95%, particularly preferably by 50% to 95%. Outside the recesses and depressions, the protective layer advantageously exhibits a thickness ds between 50 μm and 200 μm, preferably between 100 μm and 150 μm. In the depressions, the protective layer exhibits a reduced thickness d_{K} that is advantageously between 5 μm and 150 μm, preferably between about 10 μm and about 50 μm.

The depressions can exhibit, for example, a rectangular or trapezoidal cross section. Its characteristic dimension typically lies between 100 μm and 2000 μm, preferably between about 300 μm and about 1000 μm. The characteristic dimension for a circular cross section, for example, is given by the circle radius, or for a rectangular cross section, by the arithmetic mean of the side lengths.

The wetting sites disposed in the depressions advantageously exhibit a characteristic dimension of about 5 μm to about 200 μm, preferably of about 10 μm to about 100 μm, and they preferably have, as in the first aspect, a rectangular, elliptical or circular cross section.

In both aspects, the protective layer applied to the support plate expediently consists of a material that physisorbs or chemisorbs on the support plate main surface to be wetted, or binds to it covalently, coordinatively or by complex formation. In particular, it can be formed by a positive or negative photoresist, a solder resist or an organic polymer, especially cellulose, dextran or collagen. The protective layer is applied prior to wetting, with any technique matched to the protective layer material.

According to an advantageous embodiment, the support plate exhibits a base plate consisting of plastic, metal, semiconductor, glass, composite, or a porous material or a combination of these materials. In the case of a non-conductive base plate, the support plate is preferably provided with a conductive layer, for example consisting of silicon, platinum or gold, which then forms the support plate main surface to be wetted.

In a preferred development of the present invention, in both aspects, the predetermined wetting sites are functionalized with specific probe molecules. Here, in particular, probe molecules are physisorbed or chemisorbed on the predetermined wetting sites on the main surface of the support plate, or bound to it covalently, coordinatively or by complex formation.

In a particularly preferred embodiment, the predetermined wetting sites are functionalized with nucleic acid oligomers that are modified with one or more reactive groups or markers. In particular, the nucleic acid oligomers can be modified with a fluorophore for visualization.

In an advantageous variation, the support plate main surface to be wetted is formed by a gold layer and the predetermined wetting sites are functionalized with thiol-(HS—) or disulfide-(S—S—) derivatized nucleic acid oligomers.

The present invention also comprises a substrate covering for a substrate according to the first aspect of the present invention, having a covering support plate having a plurality of protruding barrier elements whose shape and size are matched with the shape and size of the supply channels of the substrate to close the supply channels in sub-regions.

In an advantageous embodiment, the barrier elements are disposed on the covering support plate such that, after the joining of the substrate covering with the substrate, they leave only one or a certain number of channel directions open. The wetting sites of the unclosed channels can then be specifically functionalized with various specific probe molecules, or supplied with an analyte fluid. Due to the closed row supply channels or column supply channels, influencing of adjacent channels is precluded.

The barrier elements can be created, for example, by laser ablation from a paint layer that covers the entire covering support plate. Depending on the application, it is possible to permanently adhere this substrate covering to the substrate, or to mount the cover movably to facilitate further wetting steps later with other or the same covering in other positions.

The present invention further comprises a flow chamber having a substrate according to the first aspect of the present invention and a substrate covering as described above. Here, the substrate covering can be permanently or detachably joined with the substrate.

According to a preferred development, the arrangement of the recesses and the supply channels of the substrate exhibit a multifold symmetry. Here, the barrier elements of the substrate covering are disposed on the covering support plate such that the substrate covering is placeable in various orientations on the substrate and thereby closes different portions of the supply channels each time. In this way, various wetting patterns can be created on the substrate with a single substrate covering.

In particular, the flow chamber can comprise a substrate having an n×n recess matrix, in which each recess lies at the intersection point of two supply channels and the row supply and column supply channels exhibit an identical cross-sectional shape. The barrier elements of the substrate covering then close, in a first orientation, the row supply channels, and in a second orientation rotated 90° against the first orientation, the column supply channels.

A method for manufacturing a substrate according to the first aspect of the present invention comprises the steps:
a) providing a support plate having a horizontal main surface,
b) applying to the support plate a flat protective layer that separates the main surface from the surroundings,
c) patterning the protective layer to create one or more supply channels having a reduced protective layer thickness, and
d) creating in the supply channel or supply channels vertical recesses that extend to the main surface of the support plate and define the predetermined wetting sites on the main surface of the support plate.

Likewise part of the present invention is a method for manufacturing a substrate according to the second aspect of the invention, comprising the steps
a) providing a support plate having a horizontal main surface,
b) applying to the support plate a flat protective layer that separates the main surface from the surroundings,
c) patterning the protective layer to create one or more depressions having a reduced protective layer thickness, and
d) creating in the depressions vertical recesses that extend to the main surface of the support plate and define the predetermined wetting sites on the main surface of the support plate.

In an advantageous method variation, as the protective layer, a solder resist is applied in a curtain coating method.

The recesses and/or the supply channels or the depressions are preferably created by means of laser ablation, especially by irradiation of sub-regions of the protective layer with continuous or pulsed laser radiation of a predetermined wavelength, preferably in the ultraviolet spectral range. The laser radiation can be aimed directly or through a lens system or a mask at the protective layer to be removed.

In creating the recesses in step d), a surface region of the support plate is expediently melted in the region of the wetting sites. Melting the surface results in reduced surface roughness and improved homogeneity of the support plate surface.

According to a preferred development, in a step e), the predetermined wetting sites are functionalized with specific probe molecules. In particular, in step e), the predetermined wetting sites can be functionalized with nucleic acid oligomers with a spotting method.

Alternatively, in step e), for a substrate according to the first aspect of the present invention, the predetermined wetting sites can be functionalized by flushing a solution with nucleic acid oligomers into the supply channels. For a substrate according to the second aspect of the present invention, the predetermined wetting sites can be functionalized by filling the depressions with a solution with nucleic acid oligomers.

Further embodiments and advantages of the present invention are described in detail below:

Applying a Protective Layer to the Substrate

According to the present invention, the substrates according to the first or second aspect are provided with a protective layer. This protective layer can bridge the critical period between the manufacture of the support plate and the wetting of its surface, as the protective layer prevents the adsorption of impurities.

For the protective layer, any material can be used that forms a complete layer on a surface and thus separates the substrate surface from the surroundings and can later be removed at desired sites, for example by laser ablation, either in its entire thickness without residue or to fractions of the original thickness. It is understood that, advantageously, for a given substrate, a matched protective layer is selected that is optimized in terms of the adhesion between the support plate and the protective layer. Likewise, the protective layer can be optimized with a view to the fluid to be used. In the case of aqueous solutions, a hydrophilic layer material is appropriate, so that the fluids wet the supply channels of the present invention and bubbles are avoided. In the case of oily fluids, on the other hand, hydrophobic material is to be preferred.

By adding detergents to the fluids used, improved wetting of the channel structures and thus good flow properties can be achieved independently of the layer material. In addition to the usual paints known in lithography (positive and negative photoresists) and printed circuit board technology (solder resists), organic polymers are also suitable, such as cellulose, dextran or collagen. It is also conceivable to use paints whose special components form advantageous functionalizations for particular applications when the material dries on the surface.

The protective layer can be applied to the support plate for example by spraying in the case of the photoresists, by spin coating or physisorption in the case of the organic polymers, or by screen printing or curtain coating in the case of the solder resists. In the preferred solder resists known in printed circuit board technology, both 2-component and 1-component solder resists that are applied by curtain coating methods, screen printing or spray methods and can subsequently cure in air or through UV irradiation are suitable. One advantage of this method variation consists in the fact that the thickness of the solder resist layer can be freely selectably set within a large range, e.g. in the curtain coating method by the speed of the support plate under the paint curtain.

Laser Ablation of the Protective Layer in Any Geometry

The term “laser ablation” is understood to be not only the partial or complete removal of organic or inorganic protective layers, but also the removal of impurities on a support plate by irradiation with laser light. In the context of the present invention, advantageously, the laser ablation is employed to remove or pattern the applied protective layer in any geometry at desired locations of the substrate. It is thus possible to realize various, precisely defined free substrate areas or regions with a tapered protective layer in different sizes on one and the same substrate design merely by changing the laser lighting.

A further aspect is the melting of the support plate surface with complete removal of the protective layer by means of laser ablation, which can be achieved by setting the laser intensity or the exposure time to the properties of the support plate and the protective layer. In addition to reducing the surface roughness, this short-term, near-surface melting of the support plate surface closes existing pores in the material and thus improves the homogeneity of the free support plate surface. In addition, by the ablation of a few gold layers, impurities are removed from the surface.

The laser ablation can occur by direct irradiation of the light or by irradiation of the light through a lens system or a mask. Here, the size or the shape of the individual wetting sites to be exposed or patterned and their lateral spacing are arbitrary and depend only on the respective application. The wavelength of the laser light used, as well as the exposure time or the number and duration of the pulses depend on the combination of the protective layer and the material of the support plate surface, and are preferably optimized for each pair.

In a preferred variation of the present invention, with an excimer laser are scribed in a solder resist, through multiple masks in multiple process steps, structures, comprising channels or depressions and recesses extending to the support plate, that facilitate the targeted wetting of the free or functionalized wetting sites with one or more different fluids containing the analytes.

For example, in solder resist layers of typically 100-150 μm in thickness are cut with a certain number of laser pulses various channels of 80-100 μm in depth and 10-150 μm in width and then, within the channels, by additional laser pulses, the substrate is exposed at one or more locations having diameters of about d=10-100 μm in order to define the wetting sites. Here, the lateral dimensions of the exposed wetting sites are smaller or equal to the width of the supply channels.

Functionalization of the Exposed Substrate Sites

In the context of the present invention, functionalization of the substrate surface is understood to mean the application to the substrate wetting sites of molecules that can specifically bind other molecules from a sample substance. For functionalization, these molecules, dissolved in any organic and inorganic solvents or mixtures of fluids, are brought into contact with the main surface of the support plate. After a certain incubation time, the probe molecules (ligates) are present physisorbed or chemisorbed on the substrate or bound to it covalently, coordinatively or by complex formation.

In the field of sensorics, with the present invention, all types of ligates that are applied to the wetting sites on the support plate can be brought into contact in a controlled manner with various analyte fluids, and these can be analyzed for the presence of their specific ligands. The term ligate refers to molecules that specifically interact with a ligand to form a complex. Examples of ligates within the meaning of the present text are substrates, cofactors or coenzymes, as complex binding partners of a protein (enzyme), antibodies (as complex binding partners of an antigen), antigens (as complex binding partners of an antibody), receptors (as complex binding partners of a hormone), hormones (as complex binding partners of a receptor), nucleic acid oligomers (as complex binding partners of the complementary nucleic acid oligomer) and metal complexes.

In a preferred embodiment of the present invention, the free wetting sites are wetted with modified nucleic acid oligomers in aqueous solution. The nucleic acid oligomer that is to be applied to the free surface is modified with one or more reactive groups via a covalently attached spacer of any composition and chain length, these reactive groups preferably being located near one end of the nucleic acid oligomer. The reactive groups are preferably groups that can react directly with the unmodified surface. Examples of this are: (i) thiol-(HS—) or disulfide-(S—S—) derivatized nucleic acid oligomers having the general formula (n×HS-spacer)-oligo, (n×R—S—S-spacer)-oligo or oligo-spacer-S—S-spacer-oligo that react with a gold surface to form gold-sulfur bonds, (ii) amines that absorb on platinum or silicon surfaces by chemisorption or physisorption and (iii) silanes that enter into a covalent bond with oxidic surfaces.

On the other side of the nucleic acid oligomer, the molecule is modified with a fluorophore via a further spacer of any composition and chain length to visualize the functionalization of the free substrate locations. For the functionalization of the exposed sites, both flushing via suitable supply channels and spotting techniques may be used.

Manufacturing of Substrate Coverings for the Realization of Flow Chambers and for the Introduction of Variable Fluid Barriers into the Channel Structures

In the context of the present invention, with the aid of laser ablation, coverings can also be manufactured for the respective substrates having differing channel structures. These coverings not only constitute a closure of the channel structures for realizing flow chambers, but they can also introduce, at desired locations, barriers for the analyte fluids in the channels. With these barriers, in the case of channel arrangements having intersecting channels, the flowing of fluids from one channel into the abutting channels can be prevented and cross-reactions thus precluded.

To manufacture the above-described covering, any covering support plate can be coated with solder resist whose thickness corresponds to the depth of the channels of the associated channel structure. Thereafter, the paint is removed by laser ablation such that only the desired barriers remain. The length of these barriers is expediently given by the width of the supply channels and the width of the barriers by the lateral spacing of the channels. In this way, particularly good shielding of adjacent supply channels is achieved.

If a multifold symmetry is realized in the design of the channel structures of the substrates, a single covering can function successively as the barrier for various sub-groups of the supply channels by rotating it along the symmetry angle. Here, substrate coverings that leave either only one or multiple of the various channel directions open are possible.

By using a substrate having exposed, functionalized wetting sites at the intersection points of channel structures having k-fold symmetry and a suitable, movable covering, all wetting sites of the matrix can be wetted successively and in a controlled manner with up to k/2 different analyte fluids without cross-reactions occurring. In the case of an arrangement of groups of channels that are perpendicular to each other, each having reaction vessels at the crossing point of two channels (4-fold symmetry), in the case of an n—n matrix of wetting sites, n² combinations of potential binding partners can be analyzed.

In a preferred embodiment of the present invention, the above-described coverings can be manufactured from glass substrates coated with solder resist.

### BRIEF DESCRIPTION OF THE DRAWINGS

The invention will be explained in greater detail below by reference to exemplary embodiments in association with the drawings. Only the elements that are essential to understanding the present invention are depicted. Shown are:

FIG. 1 a schematic diagram of the arrangement of supply channels and wetting sites in a substrate according to an embodiment of the present invention;

FIG. 2 a cross section through the substrate of FIG. 1 along the line II-II, in part with functionalized wetting sites;

FIG. 3 in (a) and (b), SEM images of wetting locations exposed by laser ablation in a solder resist protective layer;

FIG. 4 in (a), an AFM image of a lasered and melted gold surface, and in (b), a cross-sectional height profile along the line B-B in FIG. 4(a);

FIG. 5 a fluorescence image of nucleic acid oligomers, modified with fluorophore, that are immobilized on exposed wetting sites of a substrate;

FIG. 6 a schematic diagram of the detection of nucleic acid oligomer hybridization events with high salt content, by modulation of the fluorescence quenching on quench surfaces;

FIG. 7 in (a) to (d), a schematic diagram of the arrangement of supply channels according to further embodiments of the invention;

FIG. 8 in (a), a section of a possible channel structure and in (b), the section of an associated substrate covering, based on the example of an exposed, square site at the crossing point of two channels having a covering that, depending on positioning, can block one of the channels. In FIG. 8(a), a portion of the paint layer is depicted as transparent in order to show the inside of the structure.

FIG. 9 in (a), the substrate in FIG. 7(c), in which each wetting site lies at the intersection point of two supply channels that are perpendicular to each other, in (b), an associated substrate covering that can be placed in multiple orientations on the substrate, in (c), the substrate having closed column supply channels and in (d), the substrate having closed row supply channels;

FIG. 10 a schematic diagram of a substrate having a depression according to another embodiment of the present invention; and

FIG. 11 a cross section through the substrate of FIG. 10 along the line XI-XI, in part with functionalized wetting sites.

### PREFFERED EMBODIMENTS

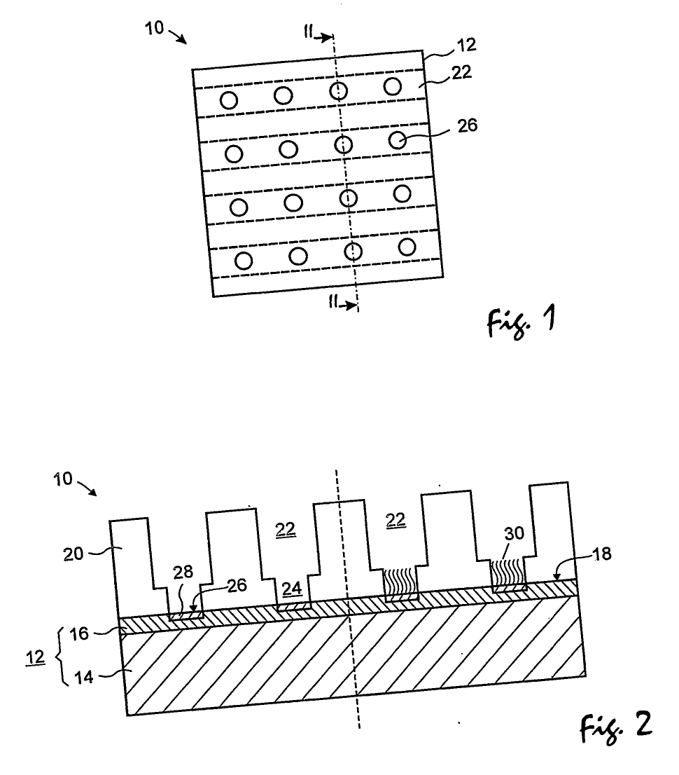

A substrate 10 for the controlled wetting of predetermined wetting sites according to a first embodiment of the present invention and a method for its manufacture will now be explained in greater detail with reference to FIGS. 1 and 2. FIG. 1 shows the substrate 10 as viewed from above and FIG. 2 depicts a cross section through the substrate 10 along the line II-II in FIG. 1. For the sake of clarity, in FIGS. 1 and 2 and in some of the subsequent figures is depicted a substrate having a matrix of merely 4×4 wetting sites. It is understood that larger matrices lie within the scope of the present invention and are preferred for the parallel analysis of a number of possible reactions.

The substrate 10 comprises a support plate 12 that, in the present embodiment, is formed by a glass slide 14 having a vapor-deposited gold layer 16. For this, on the glass slide 14 is first vapor deposited a 5-nm-thick CrNi contact layer, not depicted in the figures, and on this then a 200-nm-thick gold layer 16.

A 2-component solder resist (Elpemer GL 2467 SM-DG, from the Peters company) is applied to the support plate 12 in a curtain coating method known from printed circuit board technology, to form a protective layer 20 for the surface 18 of the support plate 12. By varying the transportation speed of the support plate 12 under the paint curtain, the preferred thicknesses of the protective layer 20 in the range of about 10-150 μm can be achieved. In the embodiment in FIGS. 1 and 2, the protective layer 20 exhibits a thickness d_{S} of about 150 μm.

After the drying of the paint, the protective layer 20 is patterned by laser ablation with an excimer laser from Lambda Physik. The laser can be imaged on the substrate 10 in reduced form through various masks, the surface intensity of the radiation being set via the imaging apparatus. In this way, depending on the mask, various geometries of the ablated regions can be realized.

With the aid of laser ablation, two structures are scribed in the solder resist protective layer 20. In a first patterning step, supply channels 22 are cut into the paint through a first mask, the depth of these channels 22 being able to be set by the number of laser pulses. A channel depth of about 80-120 μm is achieved, for example, with about 540-900 pulses (of 20 ns) with a fluence of 600-1200 mJ/cm². Depending on the application and the desired lateral spacing (typically in the range of 50-200 μm), the width of the channels can be set arbitrarily and typically ranges from 10-150 μm. In the exemplary embodiment, the substrate 10 includes, having a rectangular cross section, four parallel row supply channels 22 that exhibit a depth of about 100 μm and a width of about 70 μm. Within the channels, the thickness of the protective layer 20 is thus reduced from its initial value d_{S} to a value d_{K} of about 50 μm.

Thereafter, in a second patterning step through a second mask, vertical recesses 24 (FIG. 2) are created in the row channels 22 that extend to the gold surface 18 of the support plate 12. The vertical recesses 24 thus define the wetting sites 26 on the support plate 12. This is depicted in the left half of FIG. 2.

For patterning, the number and intensity of the laser pulses is set such that the surface 18 of the support plate 12 is melted in a surface region 28. In this way, reduced surface roughness and improved homogeneity of the surface is achieved. In addition, by the ablation of a few gold layers, impurities are removed from the surface. The exposed wetting areas typically have a characteristic dimension of about 10 to 100 μm. In the present embodiment, the recesses 24 and the wetting sites 26 are circular and have a diameter of about 40 μm.

As described in detail below, the wetting sites 26 can be wetted with a fluid via the supply channels 22, and in this way functionalized, for example, with specific probe molecules 30. A substrate having functionalized wetting sites 26 is depicted in the right half of FIG. 2.

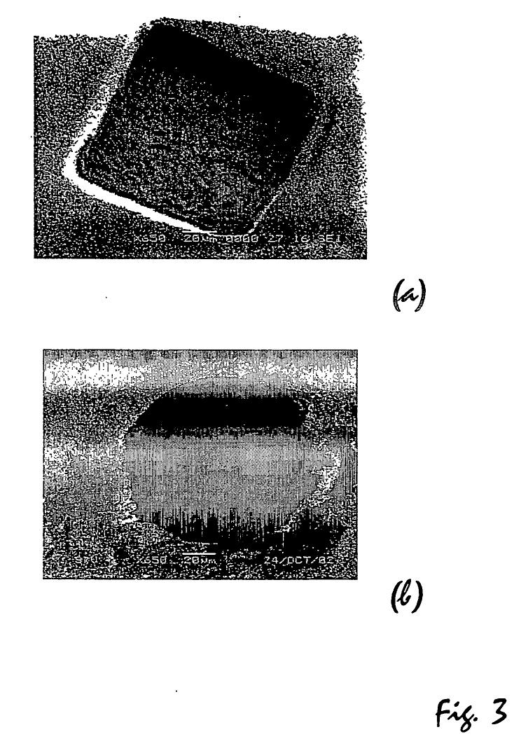

FIG. 3 shows SEM images of wetting sites 26 exposed by laser ablation in a solder resist protective layer 20. Here, both rectangular/square cross sections, as shown in FIG. 3(a), and round cross sections, as depicted in FIG. 3(b), are possible.

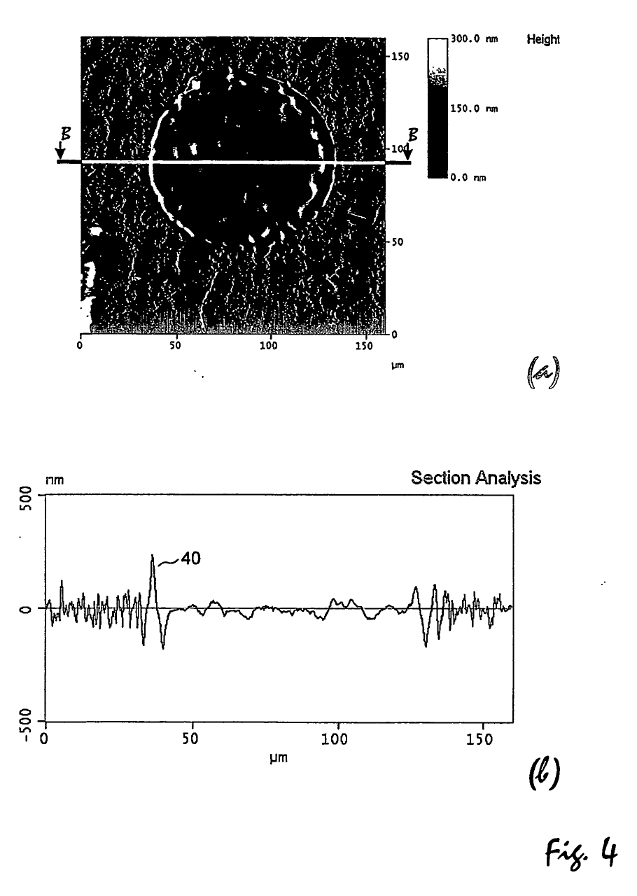

The surface structure improvement associated with the melting of the gold surface of the support plate 12 is illustrated in FIG. 4. FIG. 4 shows, in (a), an AFM image of a gold surface that was melted in a circular sub-region through laser bombardment, and in FIG. 4(b), a height profile 40 along the line B-B in FIG. 4(a). It can be clearly seen that, due to the melting, the roughness of the surface is reduced and the homogeneity of the irradiated area is increased. This facilitates the later attachment of specific probe molecules to the wetting sites 26.

Functionalization of the Wetting Sites of the Substrate with Nucleic Acid Oligomers

The wetting sites 26 of the substrate 10 can be functionalized with nucleic acid oligomers by, for example, a spotting method. The synthesis of the oligonucleotides occurs in an automatic oligonucleotide synthesizer (Expedite 8909; ABI 384 DNA/RNA Synthesizer) according to the synthesis protocols recommended by the manufacturer for a 1.0 μmol synthesis. In the syntheses with the 1-O-dimethoxytrityl-propyl-disulfide-CPG support (Glen Research 20-2933), the oxidation steps are carried out with a 0.02 molar iodine solution to avoid oxidative cleavage of the disulfide bridge. Modifications at the 5′-position of the oligonucleotides occur with a coupling step extended to 5 min. The amino modifier C2 dT (Glen Research 10-1037) is built into the sequences with the respective standard protocol. The coupling efficiencies are determined online during the synthesis, photometrically or conductometrically, via the DMT cation concentration.

The oligonucleotides are deprotected with concentrated ammonia (30%) at 37° C. for 16 h. The purification of the oligonucleotides occurs by means of RP—HPL chromatography according to standard protocols (mobile solvent: 0.1 molar triethylammonium acetate buffer, acetonitrile), and the characterization by means of MALDI-TOF MS. The amine-modified oligonucleotides are coupled to the corresponding activated fluorophores (e.g. fluorescein isothiocyanate) in accordance with the conditions known to the man skilled in the art. The coupling can occur either prior to or after the attachment of the oligonucleotides to the surface.

To the substrate 10 according to FIG. 1 is applied doubly modified 20-bp single-strand oligonucleotide having the sequence 5′-AGC GGA TAA CAC AGT CAC CT-3′ (modification one: the phosphate group of the 3′-end is esterified with (HO—(CH₂)₂—S)₂ to form P—O—(CH₂)₂—S—S—(CH₂)₂—OH, modification two: to the 5′-end is built in the flourescein modifier fluorescein phosphoramidite (Proligo Biochemie GmbH) according to the corresponding standard protocol) as a 5×10⁻⁵ molar solution in buffer (phosphate buffer, 0.5 molar in water, pH 7 with 0.05 vol.% SDS) with the addition of approx. 10⁻⁵ to 10⁻¹ molar propanethiol (or other thiols or disulfides of suitable chain length) with the aid of a spotter (Cartesian) and incubated for 2 min-24 h. During this reaction time, the disulfide spacer P—O—(CH₂)₂—S—S—(CH₂)₂—OH of the oligonucleotide is homolytically cleaved. Here, the spacer forms a covalent Au—S bond with Au atoms of the surface, thus causing a 1:1 coadsorption of the ss-oligonucleotide and the cleaved 2-hydroxy-mercaptoethanol. The free propanethiol that is also present in the incubation solution is likewise coadsorbed by forming an Au—S bond (incubation step). Instead of the single-strand oligonucleotide, this single-strand can also be hybridized with its complementary strand.

For the loading with the spotter from Cartesian Technologies (MicroSys PA), split-pin needles (Arraylt Chipmaker pins from TeleChem) are used that have a loading volume of 0.2 to 0.6 μL and release volumes of about 1 nL per wetting process. The contact surface of these needles has a diameter of about 130 μm and is thus considerably larger than the substrate regions exposed by laser ablation. The positioning of the needle above the substrate occurs with a precision of 10 μm at a humidity of about 70-80%. The droplet is released upon contact of the tip with the protective layer and no direct contact occurs with the substrate (“pseudo-contact printing”).

The loading of the free substrate sites with fluorescence-modified nucleic acid oligomers can be visualized with the aid of a fluorescence scanner from LaVision Biotech. FIG. 5 shows a fluorescence image of four wetting sites that are functionalized with nucleic acid oligomers modified in this way.

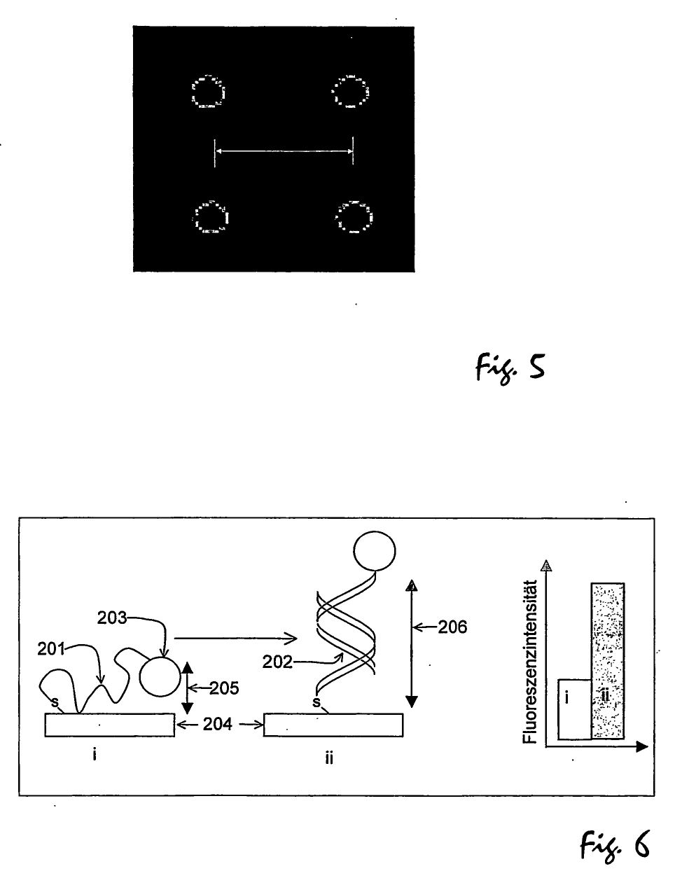

The detection principle is briefly explained with reference to FIG. 6. The detection of nucleic acid oligomer hybridization events occurs with high salt content by modulation of the fluorescence quenching on quench surfaces. Prior to the hybridization in sub-image i), the single-strand probe nucleic acid oligomer 201 is present in a form that is characterized by a small spacing 205 between the fluorophore 203 and the quenching metal surface 204, for example gold. Through the hybridization (reference number 202) with the complementary nucleic acid oligomer strand, the target, the distance 206 of the fluorophore 203 from the quenching metal surface 204 increases, as depicted in sub-image ii), and the fluorescence intensity rises significantly.

Functionalization of the Free Wetting Sites of the Substrate by Flushing Nucleic Acid Oligomers into the Supply Channels

According to the present invention, the wetting sites of the substrate 10 are preferably functionalized by flushing nucleic acid oligomers into the supply channels 22.

For this, for example, a substrate 10 as shown in FIGS. 1 and 2 having a 4×4 matrix of exposed wetting sites 26 is used. The substrate is covered with a glass substrate that is coated with a homogeneous 50-μm-thick solder resist layer and thereafter, a solution with the above-described nucleic acid oligomers is flushed into the channel structure. After an incubation time of 2 min-24 h, the glass cover is removed, the substrate rinsed and the functionalization of the free sites is visualized with the aid of a fluorescence scanner. A substrate having functionalized wetting sites 26 is obtained, as illustrated in the right sub-image of FIG. 2. Since four independent row channels are provided, the wetting sites can be easily functionalized with four different nucleic acid oligomers.

### Alternative Embodiments of the Supply Channels

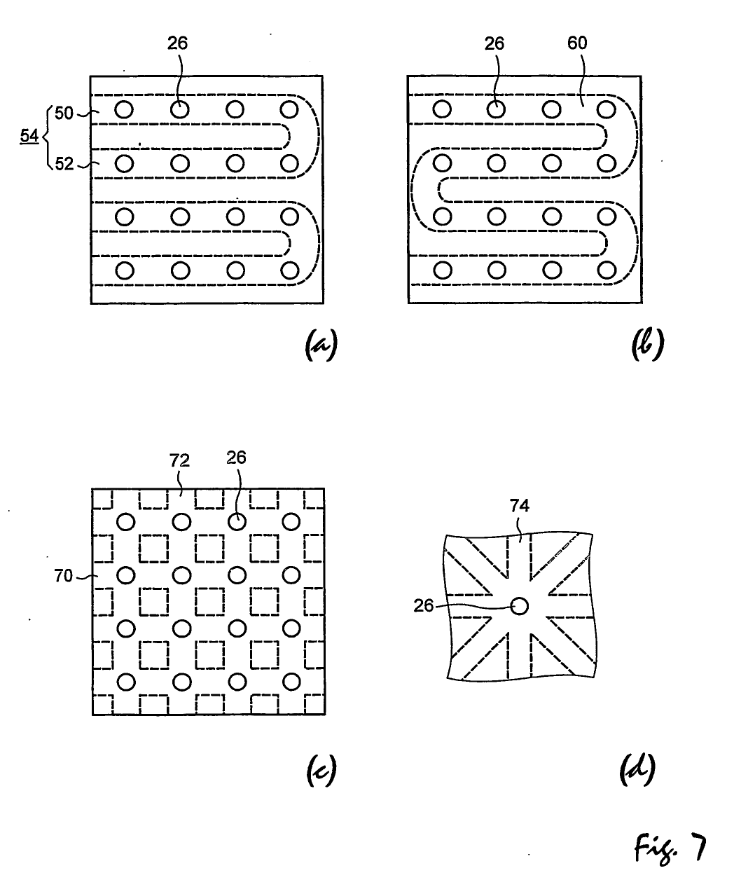

FIG. 7 shows, in (a) to (d), schematic diagrams of the arrangement of supply channels according to further embodiments of the invention.

In the embodiment in FIG. 7(a), two row channels 50 and 52 are each linked on one substrate side, so that U-shaped channels 54 are created whose inlet and outlet are located on the same side of the substrate 10.

In FIG. 7(b) is depicted an embodiment in which only a single supply channel 60 is provided, which extends meander-like across the entire substrate and includes all wetting sites 26.

For functionalizing the substrates according to FIGS. 7(a) and 7(b), they are each covered with a coated glass substrate, and a nucleic acid oligomer solution described above is flushed into the channel structure. After an incubation time of 2 min-24 h, the glass cover is removed, the substrate rinsed and the functionalization of the free sites visualized with the aid of a fluorescence scanner.

Channel structures in which the wetting sites lie at the intersection point of two or more supply channels are depicted in FIGS. 7(c) and 7(d). FIG. 7(c) shows a square matrix of row supply channels 70 and column supply channels 72, at whose intersection points one wetting site 26 each is arranged. Each wetting site 26 can thus be wetted with a fluid both via a row supply channel 70 and via a column supply channel 72. A preferred application of such a substrate is described in detail below.

Extending this concept, the wetting sites 26 can also lie at the intersection point of more than two channels. FIG. 7(d) shows a section of such a channel structure, where each wetting site 26 lies at the intersection point of four supply channels 74.

Substrate Coverings

Substrates in which the wetting sites lie at the intersection point of multiple supply channels 22 are preferably employed together with substrate coverings that, on one hand, close the supply channels 22 in the up direction to form flow chambers, and on the other hand, exhibit for the analyte fluids suitably disposed barrier elements that block a portion of the supply channels. With these barrier elements, for intersecting channels, the flowing of fluids from one channel into the adjacent channels can be prevented and cross-reactions thus avoided.

For example, a first substrate covering for blocking the column supply channels and a second substrate covering for blocking the row supply channels can be provided. However, in the context of the present invention, it is preferred that a single substrate covering is employed both for blocking the row supply channels and, after the appropriate reorientation of the covering, for blocking the column supply channels.

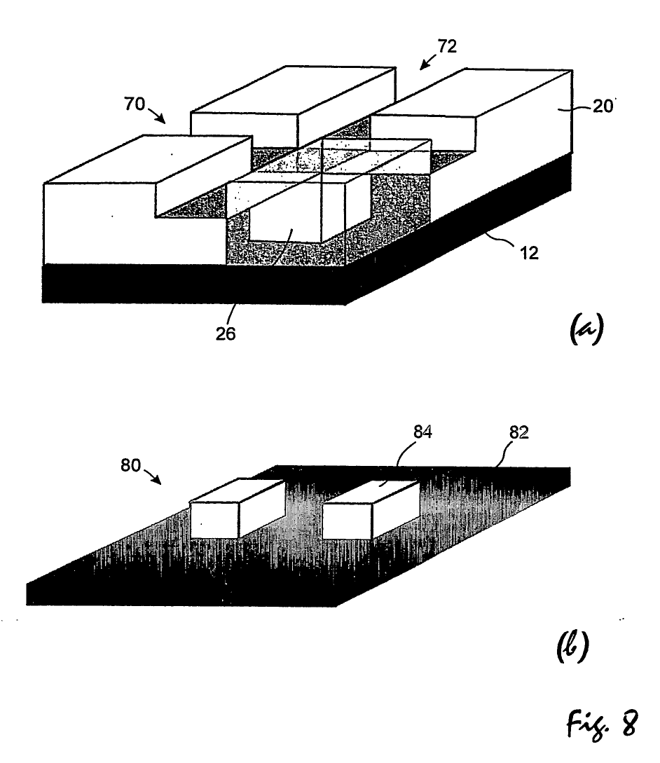

Such substrate coverings can be manufactured with the aid of laser ablation for substrates having differing channel structures. The principle is illustrated with reference to FIG. 8. FIG. 8(a) shows a section of a channel structure in which a square vertical recess 26 is disposed at the intersection point of a row supply channel 70 and a column supply channel 72. The row supply channel 70 and the column supply channel 72 both have the same rectangular cross section. A portion of the paint layer is depicted in the figure as transparent in order to show the inside of the structure.

FIG. 8(b) depicts the corresponding section of a substrate covering 80 that, depending on the orientation, can block the row supply channel 70 or the column supply channel 72. Both of the barrier elements 84 disposed on a covering support plate 82 are matched in shape and size to the shape and size of the supply channels 70 and 72 of the substrate, and due to the symmetry of the arrangement, close, in a first orientation, the row supply channel 70, and in a second orientation rotated 90° thereto, the column supply channel 72.

To manufacture such a substrate covering 80, any covering support plate 82, for example a glass slide, is coated with solder resist whose thickness corresponds to at least the depth of the channels of the substrate 10 and measures, for example, 80 to 120 μm. Thereafter, the paint is removed by laser ablation to such an extent that only the desired barrier elements 84 remain. The substrate covering can be achieved, for example, by irradiating the area outside the barriers with about 540-900 pulses (of 20 ns) of the above-mentioned excimer laser with a fluence of 600-1200 mJ/cm².

Successive Flushing of Nucleic Acid Oligomers into the Supply Channels of a Substrate Using a Substrate Covering

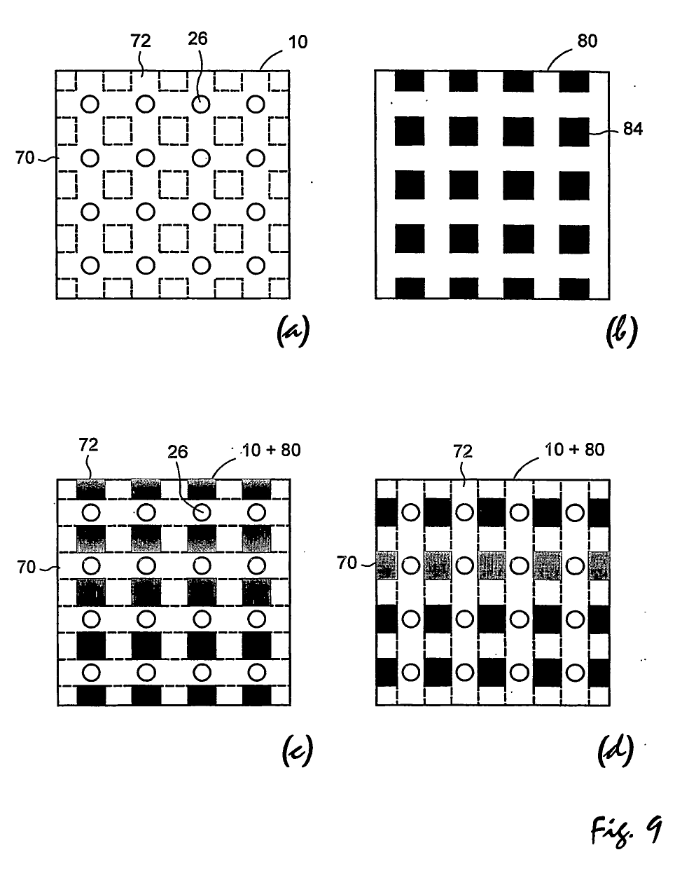

The employment of a substrate having a described substrate covering will now be explained in connection with FIG. 9. FIG. 9 shows, in (a), a substrate having 4×4 wetting sites 26 and an arrangement of parallel row supply channels 70 and column supply channels 72, as described for FIG. 7(c).

FIG. 9(b) shows the associated substrate covering 80 having the channel arrangement of matched barrier elements 84. The dimensions of the barrier elements 84 are expediently given by the width b_{K} of the supply channels 70, 72 and the lateral spacing _{—K} of the channels. In this way, particularly good screening of adjacent supply channels is achieved, since the space between the adjacent supply channels is completely filled by the barrier elements 84. The height of the barrier elements 84 corresponds to the channel depth in the substrate 10.

If the substrate covering 80 is placed in a first orientation on the substrate 10, the barrier elements 84 block precisely the column supply channels 72 and leave the row supply channels 70 open (FIG. 9(c)). In this position, into each of the four open row supply channels 70 of the substrate is flushed a solution having doubly-modified nucleic acid oligomers according to the above-described example with different sequences, that then functionalize the corresponding wetting sites 26 of the channel 70. After an incubation time of 2-24 h, the row supply channels 70 are rinsed, the covering 80 lifted and the fluorescence of the spots determined with the aid of a fluorescence scanner from LaVision Biotech, as a reference signal for the functionalization.

Now the substrate covering 80 is rotated 90° and again applied to the substrate 10 (FIG. 9(d)). Then the column supply channels 72 are each filled with an analyte fluid (0.500 molar phosphate buffer, pH 7, with 1 molar NaCl and 0.05 vol. % SDS) containing unmodified nucleic acid oligomers of various sequences. The synthesis of these oligonucleotides likewise occurs in an automatic oligonucleotide synthesizer (Expedite 8909; ABI 384 DNA/RNA synthesizer) according to the synthesis protocols recommended by the manufacturer for a 1.0 μmol synthesis.

After a suitable incubation time under hybridization conditions, the open channels are rinsed, the substrate covering 80 lifted and a second fluorescence measurement of the functionalized wetting sites 26 of the substrate conducted with the fluorescence scanner. If a certain analyte fluid contains no oligonucleotides that are complementary to the nucleic acid oligomers of a certain wetting site 26, then the fluorescence intensity of the second measurement corresponds substantially to that of the reference measurement. In the case of hybridization of immobilized oligonucleotides of a wetting site with molecules of the respective analyte fluid, a significantly higher fluorescence intensity results compared with the reference measurement, as explained above in connection with FIG. 6.

In this way, for the 4×4 matrix of wetting sites 26, 4²=16 combinations of potential binding partners can be analyzed. If larger matrices are used, a number of possible reactions can quickly be analyzed automatically and in parallel in a short time.

A further application possibility for a described substrate having an n×n matrix of wetting sites each at the intersection points of one row supply channel and one column supply channel having an associated substrate covering is the “on-chip” synthesis of nucleic acid oligomers.

Here, at the start, instead of the nucleic acid oligomers, nucleic acid monomers are flushed for functionalizing the wetting sites. Thereafter, successive further nucleic acid monomers are transported via the channel structures with the aid of substrate coverings to the desired wetting sites, where they couple with the nucleic acid oligomers present there via the phosphoramidite chemistry known in the art. Thus, nucleic acid oligomers having various sequences can be synthesized at all wetting sites of the substrate, in other words, for example, all 65,536 nucleic acid octamers on a 256×256 matrix of wetting sites.

Antibody Assay

In a further embodiment of the present invention, a substrate having a uniform matrix of 3×3 exposed wetting sites at the crossing points of two supply channels each is manufactured in analogy to FIG. 7(c), together with an associated covering.

After affixing the covering in the first orientation, into the 3 open row supply channels of the substrate are flushed 3 different antibodies (Ak₁, Ak₂, Ak₃), each of which is provided, according to standard methods, with thiol anchors for the attachment to the gold surface. After the row supply channels have been rinsed, the cover, rotated 90°, is again applied and the now open column supply channels are filled with 3 different liquid samples that contain differing compositions of proteins or antigens. After a certain incubation time, the substrate is rinsed again. Specific antibody-protein complexes have formed only on those wetting sites that were in contact with samples that contained the respective matching proteins or antigens.

For visualizing the complexes on the wetting sites, in a further step, 3 mixtures of antibodies are used, the antibodies having been modified with a fluorescence label (e.g. fluorescein) according to standard methods. With the covering again rotated 90°, these antibody mixtures are flushed into the row supply channels of the spots functionalized with identical antibodies Akᵢ. Here, the antibodies of a mixture are each matched to the possible antibody-protein complexes of the spot row such that one antibody can bind to each existing complex. After a certain incubation time, the channels are rinsed and the chip is read out with the aid of a fluorescence reader (LaVision Biotech).

Functionalization of the Free Wetting Sites of a Substrate by Flushing Nucleic Acid Oligomers into a Substrate Depression

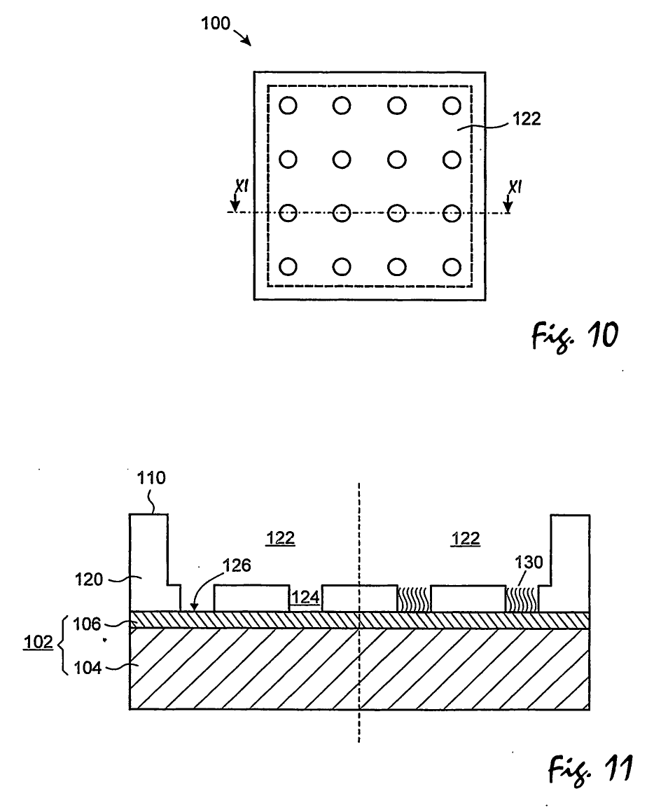

A further embodiment of the present invention is depicted in FIGS. 10 and 11. FIG. 10 shows a substrate 100 for the controlled wetting of predetermined wetting sites as viewed from above, FIG. 11 depicts a cross section through the substrate 100 along the line XI-XI of FIG. 10.

The substrate 100 comprises, like the substrate 10 of the first embodiment, a support plate 102 consisting of a glass slide 104 having a vapor-deposited CrNi contact layer and a gold layer 106 vapor deposited thereon.

To the support plate 102 is applied a 2-component solder resist to create a protective layer 120 of a thickness of about 10 to about 150 μm, in the exemplary embodiment of about 120 μm. After drying, the protective layer 120 is patterned by laser ablation with an excimer laser.

In a first patterning step, a depression 122 exhibiting a lateral dimension of 600 μm×600 μm and a depth of about 100 μm is cut into the paint. The depression 122 is surrounded by a circumferential border 110 such that a reservoir volume is created for taking up the wetting fluid.

On the bottom of the depression 122, in a second patterning step are created vertical recesses 124 having a diameter of about 30 μm that extend to the gold surface of the support plate 102 and define the predetermined wetting sites 126 on the support plate (left half of FIG. 11).

For functionalizing the wetting sites 126, the depression is filled with the nucleic acid oligomers 130 of the above-described example, rinsed after an incubation time of 2-24 h, and the functionalization of the free sites depicted in the right half of FIG. 11 is visualized with the aid of a fluorescence scanner from LaVision Biotech.

1. A substrate for the controlled wetting of predetermined wetting sites with small fluid volumes comprising:
a support plate having a horizontal main surface for wetting with a fluid at predetermined wetting sites; and
a flat protective layer applied to the support plate that separates the main surface from the surroundings,
said protective layer comprising vertical recesses extending to the main surface of the support plate that define the predetermined wetting sites on the support plate, and
one or more supply channels leading to the vertical recesses for supplying the wetting fluid to the predetermined wetting sites, said supply channels having reduced thickness in the flat protective layer.

2. The substrate according to claim 1, characterized in that the vertical recesses are disposed in the supply channel or supply channels.

3. The substrate according to claim 1, characterized in that each vertical recess lies in one supply channel.

4. The substrate according to claim 1, characterized in that each vertical recess lies at the intersection point of multiple supply channels.

5. (canceled)

6. The substrate according to one of the preceding claims, characterized in that the vertical recesses or groups of recesses are disposed in the form of an n×m matrix having n rows and m columns, n and m being greater than or equal to 2, and n and m each preferably lying between 10 and 1000.

7. The substrate according to claim 6, characterized in that the number n of rows and the number m of columns are identical.

8. The substrate according to claim 6 characterized in that the m recesses or groups of recesses in one row are disposed in one of n parallel row supply channels.

9. The substrate according to claim 8, characterized in that the n recesses or groups of recesses in one column are each disposed in one of m parallel column supply channels, so that each recess lies at the intersection point of two supply channels.

10. The substrate according to claim 9, characterized in that the row supply channels and the column supply channels exhibit an identical cross-sectional shape.

11. The substrate according to claim 6 characterized in that each one n′×m′ sub-matrix of recesses or groups of recesses is disposed in one meander-shaped supply channel, wherein n=kₙ*n′ and m=kₘ*m′, with integers kₙ and kₘ being greater than or equal to 1.

12. (canceled)

13. (canceled)

14. (canceled)

15. The substrate according to claim 1 characterized in that the supply channels run substantially parallel to the main surface of the support plate.

16. The substrate according to claim 1 characterized in that the supply channels exhibit a rectangular or trapezoidal cross section.

17. (canceled)

18. (canceled)

19. The substrate according to claim 1 wherein the vertical recesses exhibit a substantially rectangular, elliptical or circular cross section.

20. The substrate according to claim 1 wherein the protective layer consists of a material that physisorbs on the support plate main surface to be wetted, chemisorbs on the support plate main surface to be wetted, or binds to the support plate main surface to be wetted.

21. The substrate according to claim 1 wherein in that the protective layer is formed by a positive or negative photoresist, a solder resist or an organic polymer, especially cellulose, dextran or collagen.

22. The substrate according to claim 1 wherein the support plate comprises a base plate selected from the group consisting of plastic, metal, semiconductor, glass, composite or a porous material.

23. The substrate according to claim 1 wherein the predetermined wetting sites are functionalized with specific probe molecules.

24. The substrate according to claim 23, characterized in that the predetermined wetting sites are functionalized with nucleic acid oligomers that are modified with one or more reactive groups.

25. (canceled)

26. (canceled)

27. The substrate according to claim 1 wherein the substrate is covered with a cover plate that closes the supply channels in the up direction to form flow chambers.

28-44. (canceled)

45. A substrate covering for a substrate according to one of claim 1 having a covering support plate having a plurality of protruding barrier elements whose shape and size are matched with the shape and size of the supply channels of the substrate to close the supply channels in sub-regions.

46. The substrate covering according to claim 45 wherein the barrier elements are disposed on the covering support plate such that, after the joining of the substrate covering with the substrate, the barrier elements close the row supply channels or the column supply channels.

47. (canceled)

48. (canceled)

49. (canceled)

50. A method for manufacturing a substrate for the controlled wetting of predetermined wetting sites with small fluid volumes comprising the steps:
providing a support plate having a horizontal main surface;
applying to the support plate a flat protective layer that separates the main surface from the surroundings;
patterning the protective layer to create one or more supply channels having a reduced protective layer thickness; and
creating in the supply channel or supply channels vertical recesses that extend to the main surface of the support plate and define the predetermined wetting sites on the main surface of the support plate.

51. (canceled)

52. The method according to claim 50 wherein the protective layer is a solder resist applied with a curtain coating method.

53. The method according to claim 50 wherein the recesses, the supply channels or the depression are created by means of laser ablation, especially by irradiation of sub-regions of the protective layer with continuous or pulsed laser radiation of a predetermined wavelength, preferably in the ultraviolet spectral range.

54-58. (canceled)
